(19) United States
(12) Patent Application Publication
(10) Pub. No.: US 2006/0096648 A1
(43) Pub. Date: May 11, 2006

(54) Fluid diversion device

(76) Inventor: Frantz Guerrier, Stockbridge, GA (US)

Correspondence Address: WINSTEAD SECHREST & MINICK P.C., PO BOX 50784, DALLAS, TX, 75201, US

(21) Appl. No.: 10/981,805

(22) Filed: Nov. 5, 2004

(51) Int. Cl. F16K 1/16

(52) U.S. Cl. 137/875

(57) ABSTRACT

A flapper valve assembly for influencing the flow of a fluid into one of two distinguishable flow paths, comprising: (a) a substantially “Y” shaped fluid conduit having an inlet flow portion, an exiting flow portion, and a divergent flow portion with the divergent flow portion intersecting the inlet flow portion at an angular offset between XX and YY degrees; (b) a flapper valve ball seat positioned at a point of convergence between divergent flow and exiting flow portions; (c) a flapper valve positionally accommodated within the flapper valve ball seat and extending sufficiently to traverse entry of a fluid into either the divergent flow portion or the exiting flow portion of the conduit; and, (d) a flapper valve manipulation means by which the flapper valve may be exercised to transitionally traverse and seal the divergent flow portion or the exiting flow portion of the conduit.

### FIELD OF THE INVENTION

The invention relates to a flapper valve assembly adapted for leaning Y-shape fluid conduits. In general and in particular, to a flapper valve assembly for influencing the flow of fluid into flow paths.

### BACKGROUND OF THE INVENTION

U.S. Pat. No. 3,705,602, purports to disclose and claim a non-return valve for positioning in a pipe socket and having a flap member rotatable around a shaft. The shaft is arranged in a plane at a given distance from the plane of the flap, whereby the flap in an open position is passed circumfluently by the medium flowing through the valve.

U.S. Patent Application Publication No. US 2002/0112857 A1, purports to disclose and claim a well completion apparatus and method comprising a junction assembly having a template and a lateral branch connector sealably engageable with the template to couple a main bore to a lateral branch bore. The template has a lateral window for positioning proximal a junction of the lateral branch bore and the main bore. The lateral branch connector is adapted to be engaged in the in the template so that a portion of the connector extends through the lateral window of the template. Plural flow paths comprise a first flow path in communication with the lateral branch, and a second flow path for communicating with a portion of the main bore below the junction.

### BRIEF SUMMARY OF THE INVENTION

A flapper valve assembly for influencing the flow of a fluid into one of two distinguishable flow paths, the assembly comprising:

(a) a substantially “Y” shaped fluid conduit 3, the inner portion thereof having an inlet flow portion, an exiting flow portion, and a divergent flow portion, the divergent flow portion intersecting the inlet flow portion at an angular offset between XX and YY degrees;

(b) a flapper valve ball seat positioned at a point of convergence between divergent flow portion and exiting flow portion;

(c) a flapper valve 18 positionally accommodated within the flapper valve ball seat 15 and extending sufficiently to traverse and generally preclude entry of a fluid into either the divergent flow portion or the exiting flow portion of the conduit; and,

(d) a flapper valve manipulation means by which the flapper valve may be exercised to transitionally traverse and seal the divergent flow portion or the exiting flow portion 9 of the conduit.

### BRIEF DESCRIPTION OF THE DRAWINGS

FIG. 1 is a cutaway view of the valve assembly of the present invention, with the invention's flapper valve in a position to influence a fluid flow through an exiting flow portion of the conduit.

FIG. 2 is a cutaway view of the valve assembly of FIG. 1 showing the flapper valve in a position to influence a fluid flow through the divergent flow portion of the assembly.

FIG. 3 is a cutaway view of the valve assembly of FIGS. 1 and 2 when viewed from the front illustrating the flapper valve in a position to influence water flow through the divergent portion of the valve.

FIG. 4 is an illustration of the instant invention as deployed in a typical household or industrial application providing further detail with respect to the flapper valve's deployment to influence fluid flow through the divergent flow portion of the valve assembly and into a fluid containment vessel.

### DETAILED DESCRIPTION OF THE INVENTION

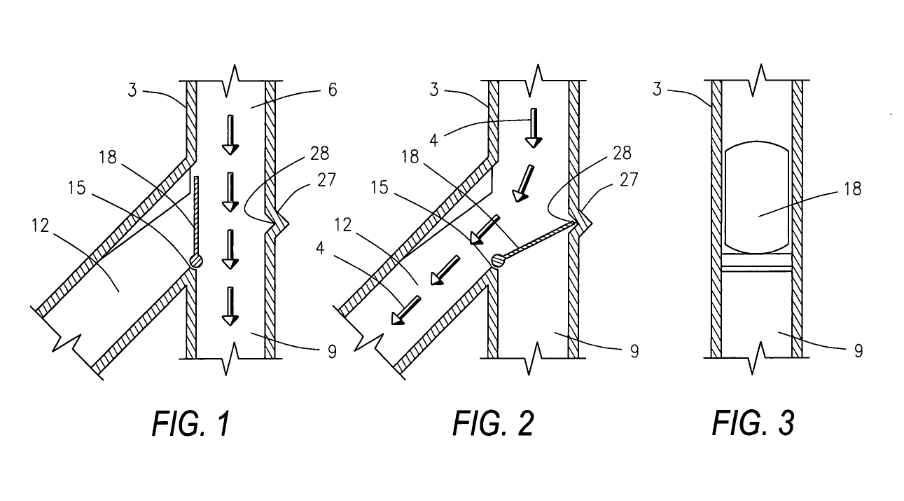

The principles of the present invention and their advantages are best understood by turning now to FIG. 1. In FIG. 1 the instant invention is shown leaning Y-shaped or generally Y-shaped fluid conduit 3. The inner portion of conduit 3 illustrates an inlet flow portion 6 and exiting flow portion 9 and a divergent flow portion 12 of the conduit. As seen in FIG. 1, the divergent flow portion 12 intersects the inlet flow portion 6 at an angular offset between XX and YY degrees.

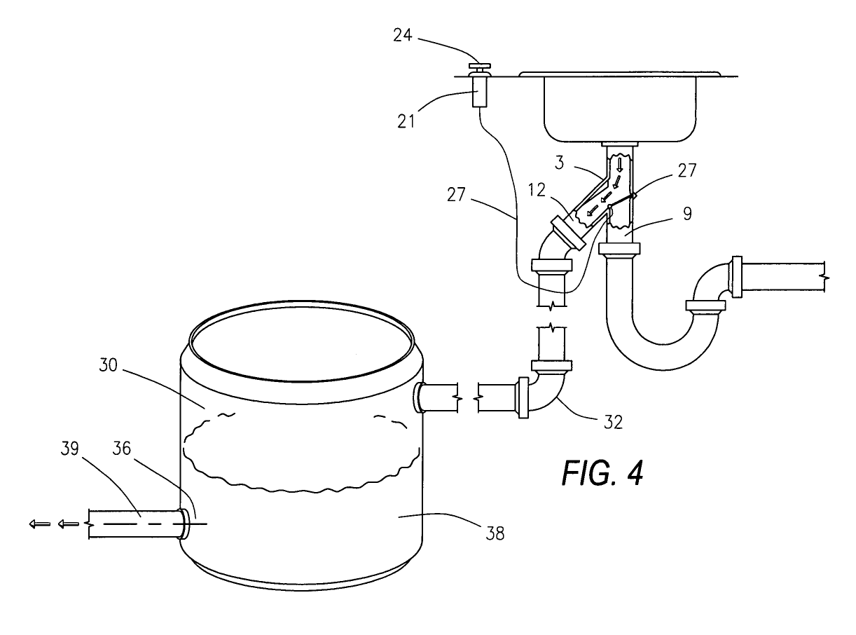

Also, shown in FIG. 1 is a flapper valve ball seat 15 which is positioned at a point of convergence between the divergent flow portion 12 and exiting flow portion 9. A flapper valve 18 is positionally accommodated within the flapper valve ball seat 15 and is shown extending sufficiently to traverse and generally preclude entry of a fluid into either the divergent flow portion 12 or the exiting flow portion 9 of the conduit. The transitional positioning of flapper valve 18 is facilitated by a valve manipulation means 24 (not shown FIG. 1—further illustrated and discussed in association with FIG. 4) by which flapper valve 18 may be exercised to traverse and seal the divergent flow portion 12 or exiting flow portion 9 of the conduct.

FIG. 2 illustrates a cutaway view of the valve assembly of FIG. 1 showing the flapper valve 18 positioned to influence a fluid flow through the divergent flow portion of the conduit 12. In FIG. 2 it is shown where the flapper valve 18 has been urged to position itself in a manner which precludes passage of water denoted by arrows 4 from entering into the exiting flow portion 9 of the conduit 3. As seen in FIG. 2, water flow 4 in this valve setting, diverges fluid through flow portion 12 of conduit 3. A readily apparent comparison of alternative flow path directions of the instant invention may be had by comparing FIG. 2 to FIG. 1 where flapper valve 18 has been exercised or otherwise urged to seal off the divergent flow portion 12, and facilitate water flow 4 through the exiting flow portion 9 of valve assembly 3. Also shown in conjunction with FIG. 2 and FIG. 1 is an extruded portion 27 of valve assembly 3. The inner portion of extrusion 27 provides a resting surface 28 upon which the lower surface of flapper valve 18 may be positioned when traversing the exiting flow portion 9 of the conduit 3.

Turning now to FIG. 3. In FIG. 3 the valve assembly of FIGS. 1 and 2 is shown from a front view perspective in cutaway where valve 18 seals divergent flow portion 12 to induce water flow through exiting flow portion 9.

FIG. 4 illustrates the instant invention as deployed in a typical household or industrial application providing further detail with respect to the flapper valve's deployment to influence fluid flow through the divergent portion 12 of the valve assembly and into a fluid containment vessel 30. In FIG. 4 it is shown where the valve assembly of the present invention further comprises a divergent fluid containment vessel 30 which is in adaptable communication with the divergent flow portion 12 of exiting conduit 32. The containment vessel 30 further embodies an exiting aperture 36 by which divergent fluid 38 contained within vessel 30 may be purged or routed. A rerouting conduit 39 is also shown in FIG. 4 and in applications most relevant to the present invention, conduit 39 may be adaptively connected to a residential or industrial water inlet accommodation. In so doing, it is envisioned the benefits of the instant invention enhances the art of water recycling by allowing a homeowner to store for a temporary period water that has entered an industrial or residential setting, incurred costs associated with fluid such as water delivery and having served a useful purpose may be utilized for yet subsequent applications.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended Claims.

It is therefore, contemplated that the Claims will cover any such modifications or embodiments that fall within the true scope of the invention.

What is claimed is:

1. A flapper valve assembly for influencing the flow of a fluid into one of two distinguishable flow paths, the assembly comprising:
(a) a substantially “Y” shaped fluid conduit 3, the inner portion thereof having an inlet flow portion 6, an exiting flow portion 9, and a divergent flow portion 12, the divergent flow portion 9 intersecting the inlet flow portion at an angular offset between XX and YY degrees;
(b) a flapper valve ball seat 15 positioned at a point of convergence between divergent flow and exiting flow portions 9;
(c) a flapper valve 18 positionally accommodated within the flapper valve ball seat 15 and extending sufficiently to traverse and generally preclude entry of a fluid into either the divergent flow portion 12 or the exiting flow portion 9 of the conduit; and,
(d) a flapper valve manipulation means 24 by which the flapper valve 18 may be exercised to transitionally traverse and seal the divergent flow portion 12 or the exiting flow portion 9 of the conduit.

2. The assembly of claim 1 wherein a section of the inner flow portion is extruded 27 to form a bracing surface upon which the lower surface of the flapper valve 18 may be positioned when traversing the exiting flow portion 9 of the conduit.

3. The assembly of claim 1 further comprising a divergent fluid containment vessel 30 in adaptable communication with the divergent flow portion 12 of the conduit, the divergent fluid containment vessel 30 having an exiting aperture 36 by which divergent fluid contained therein may be purged or routed.

4. The assembly of claim 1 further comprising a re-routing conduit 39 attachably connected to the exiting aperture and a residential or industrial water 12 accommodation.
